(19) United States
(12) Patent Application Publication
(10) Pub. No.: US 2026/0242080 A1
(43) Pub. Date: Aug. 20, 2026

(54) METHOD FOR PRODUCING A PACKAGE AND PACKAGING MACHINE

(71) Applicant: MULTIVAC MARKING & INSPECTION GMBH & CO. KG, Enger (DE)

(72) Inventors: Andreas REICHERT, Lage (DE); Michael REFFKE, Rödinghausen (DE); Markus DAUWE, Hilter (DE); Udo HENRICHS, Bielefeld (DE); Leonie KIRCHHOF, Bielefeld (DE)

(73) Assignee: MULTIVAC MARKING & INSPECTION GMBH & CO. KG, Enger (DE)

(21) Appl. No.: 19/396,236

(22) Filed: Nov. 20, 2025

(30) Foreign Application Priority Data
Nov. 28, 2024 (DE) 102024135231.0

(51) Int. Cl. B65B 7/16; B65B 7/28; B65C 1/04; B65C 9/18

(52) U.S. Cl. CPC B65B 7/162; B65B 7/2842; B65C 1/04; B65C 9/1869

(57) ABSTRACT

A method for producing a package in a direction of production, comprises: providing a label roll comprising prefabricated labels and a carrier layer to which the labels are glued; providing packaging bases loaded with a product; separating the labels from the carrier layer at a dispensing edge, wherein the respective labels form lid members for the packaging bases; and closing the packaging bases in a closing process to form closed packages in that the lid members formed from the labels are glued on along a tray edge formed on the respective packaging bases; wherein the lid members are received at the dispensing edge by a belt device that is associated with the dispensing edge and that merges the lid members with the respective tray edges of the packaging bases for the closing process, and that presses the labels forming the lid members onto the tray edges at least in sections.

### CROSS-REFERENCE TO RELATED APPLICATIONS

This application claims foreign priority benefits under 35 U.S.C. § 119(a)-(d) to German patent application number 102024135231.0, filed Nov. 28, 2024, which is incorporated by reference in its entirety.

### TECHNICAL FIELD

The present disclosure relates to a method for producing a package and to a packaging machine.

### BACKGROUND

DE 10 2017 114 027 B3 discloses a device by way of which a closure label can be mechanically applied to the circumferential edge of a plastic tray suitable for receiving food, i.e., the plastic tray can be closed with the aid of a closure label. For this purpose, the device initially comprises a motor-driven draw-off roller for receiving a carrier roll. The carrier roll, in turn, consists substantially of a carrier film onto which the closure labels intended for closing the plastic trays are glued. This carrier film is then supplied within the device by way of several deflection rollers to a dispensing edge, in the region of which the carrier film is deflected by approximately 180 degrees. The aforementioned closure labels are detached from the carrier film in this region with this deflection or with the additional use of a detachment tab. At the same time, the plastic trays open at the top are guided to the dispenser edge from below with the aid of a conveyor belt such that the closure labels detached in the region of the dispenser edge are applied to the open side of the plastic trays and cover the top of the plastic trays. Under the influence of a pressure die arranged in the conveying direction of the conveyor belt further downstream, the closure labels applied to the plastic trays can be pressed along the circumferential edge of the plastic trays. The adhesive bond between the closure labels and the plastic trays can thus be enhanced.

Although the pressure die mentioned in DE 10 2017 114 027 B3 is suitable for enhancing the adhesive bond between the closure labels and the plastic trays, it does not have any influence on the positioning of the closure labels on the plastic trays because the pressure die is only used once the closure labels have already been positioned on the plastic trays.

### SUMMARY

An object of the disclosure is to provide a method and a packaging machine with which packages with lid members formed from labels can be produced more accurately.

This object is satisfied by a method for producing a package according to the disclosure as well as by way of a packaging machine according to the disclosure.

The disclosure relates to a method for producing a package in one direction of production, where the method according to the disclosure comprises at least the following method steps:

providing a label roll comprising the prefabricated labels and a carrier layer onto which the labels are glued (adhesively attached);

providing packaging bases loaded with a product;

separating the labels from the carrier layer at a dispensing edge, wherein the respective labels form lid members for the packaging bases, and

closing the packaging bases in a closing process to form closed packages, in that the lid members formed from the labels are glued along a tray edge formed on the respective packaging bases.

The method according to the disclosure further provides that the lid members be received at the dispensing edge by a belt device that is associated with the dispensing edge and that merges the lid members with the respective tray edges of the packaging bases for the closing process and that presses the labels forming the lid members onto the tray edges at least in sections.

According to the disclosure, the lid members formed from labels are transferred directly to the belt device at the dispensing edge such that the labels released from the carrier layer can be received directly at the dispensing edge and accurately merged with the packaging bases supplied. This results in the labels being applied with improved accuracy to the tray edges of the packaging bases supplied. Furthermore, the labels received at the dispensing edge by way of the belt device and supplied to the tray edges are also pressed onto the lid members by way of the belt device so that they can be securely glued on there.

With the disclosure, the labels released at the dispensing edge are consequently simultaneously transported onward by way of the belt device such that they can be accurately applied to the packaging bases supplied. The advancement motion of the labels to the respective tray edges of the packaging bases is therefore supported with the aid of the belt device associated with the dispensing edge so that they can be accurately glued thereonto.

The belt device according to the disclosure therefore forms a transport device for receiving the detached labels at the dispensing edge, for transporting the labels received to the tray edges of packaging bases supplied, as well as for pressing the labels onto the tray edges. This makes it possible to continuously control the transport of the detached labels up to the tray edges, i.e., to better be in control of them, in order to accurately attach them to the tray edges.

Preferably, an advancement speed of the lid members over the dispensing edge and a belt speed of the belt device are synchronized. The lid members formed from labels can therefore be reliably received at the dispensing edge using the belt device and peeled off therefrom to accurately merge them with the packaging bases.

According to one variant, it is provided that the tray edges of the packaging bases are supported from below during the closing process, at least in sections, in that they rest on conveyor belts. This ensures that the tray edges of the packaging bases are not pushed downwardly by the belt device pressing thereonto.

In particular, the packaging bases are transported in a predetermined orientation affixed between the conveyor belts for the closing process. This further promotes accurate application of the lid members formed from labels onto the tray edges of the respective packaging bases.

One variant provides for the belt device to be operated at an incline so that they guide the lid members in the direction of production while they increasingly approach the packaging bases. Inclined belt operation of the belt device is given, in particular, when a deflection or drive roller positioned at the inlet of the belt device in the direction of production is associated with the dispensing edge such that it is positioned above the dispensing edge, and a deflection or drive roller positioned at the outlet of the belt device in the direction of production is mounted at a lower height than the deflection or drive roller positioned at the inlet. The labels can be directly received at the dispensing edge by way of an underrun or a lower belt section of the belt device for being merged with the packaging bases transported therebeneath.

The transport of the labels by way of the belt device can be adjusted such that the labels are only placed on the tray edges of the respective packaging bases when they have been completely detached from the carrier layer.

A preferred embodiment provides that the lid members glued to the tray edges be pressed on again along the respective tray edges by way of a driven roller mounted in the direction of production downstream of the belt device.

In particular, this drive roller mounted downstream of the belt device can be sized such that it presses onto the lid members across the entire width of the packaging, i.e., along all tray edges.

It would be conceivable for the belt device to be heated at least in certain regions. It would be conceivable for the belt device to be heated, in particular in a region where the labels are pressed onto the packaging bases supplied. This could promote the formation of a strong adhesive bond. A heated deflection or drive roller at the outlet of the belt device would be conceivable, via which heat is conducted into the gluing regions when the labels are pressed on.

According to one embodiment of the disclosure, the press-on force that can be generated upon the lid members by way of the belt device is dynamically controlled. It would be conceivable for the press-on force to be dynamically controlled as a function of a type of packaging base that is set or detected, in particular with regard to the material thereof.

The disclosure further relates to a packaging machine comprising a label dispenser with a dispensing edge for separating labels from a carrier layer. The disclosure provides that the packaging machine comprises a belt device associated with the dispensing edge such that by said belt device the labels can be received at the dispensing edge, be merged with the packaging bases supplied in the direction of production, and be pressed onto the tray edges of the respective packaging bases.

The belt device according to the disclosure forms a conveying device for the labels that directly adjoins the dispensing edge of the label dispenser. This allows the labels to be received at the dispensing edge in a controlled manner and be merged accurately with the packaging bases. The belt device thus ensures controlled transport of the labels, starting from their separation from the carrier layer to their application onto the tray edges. Furthermore, the belt device is used as a press-on device to firmly press the labels applied thereby onto the tray edges. Overall, this creates a tool for label application that can be used to produce accurate packaging.

The belt device is preferably present in the form of a conveyor belt. The conveyor belt can comprise a belt with cavities.

One variant provides for the belt device to have a deflection or drive roller mounted above the dispensing edge. This allows the inlet of the belt device to be shifted toward the dispensing edge such that the labels detached from the carrier layer at the dispensing edge can be received by the belt device already before they have completely detached from the carrier layer. This enables smooth transfer of the labels between the dispensing edge and the belt device, thus ensuring controlled transport.

The belt device is preferably mounted in an inclined manner. This allows labels received thereon to be applied in a selective manner to the packaging bases supplied.

One variant provides for the packaging machine to have synchronously driven conveyor belts that are disposed opposite each other transverse to the direction of production for supporting sections of the tray edges of the packaging bases. These conveyor belts can be present in the form of vertical side belts, in particular vertical side belts controlled by a common drive. Alternatively, the respective side belts can also comprise a separate drive.

It would be expedient if the packaging base parts could be transported affixed between the conveyor belts in a predetermined orientation at least transverse to the direction of production. This allows the packaging base members to be accurately merged with the lid members for the closing process.

It would be conceivable for the packaging machine to have at least one driven roller in the direction of production downstream of the belt device for pressing the labels on along the tray edges.

It would be conceivable for the driven roller to be mounted in a height-adjustable manner synchronously with a deflection or drive roller positioned at the outlet of the belt device, in particular for the height to be adjustable by way of a common drive with the deflection or drive roller positioned at the outlet of the belt device.

Preferably, the press-on force exerted upon the labels by way of the belt device and/or by way of the driven roller is dynamically controllable. This can be achieved, for example, by varying the inclination of the belt device and/or by adjusting the height of the roller.

Preferably, the belt device comprises a belt provided with cavities. In this design, the belt is advantageously used as a press-on belt, in particular as a press-on belt with increasing internal pressure during the press-on process.

According to one embodiment of the disclosure, the belt device is configured to be heatable, at least in some regions. This can improve the adhesion of the lid members formed from labels to the packaging bases supplied. A heatable deflection or drive roller positioned at the outlet of the belt device, via which heat generated can be introduced into the adhesive regions of the labels that are being pressed on, would in particular be conceivable.

### BRIEF DESCRIPTION OF THE DRAWINGS

Embodiments according to the disclosure shall be explained in more detail with reference to the following figures, where:

FIG. 1 shows a packaging machine with a label dispenser;

FIG. 2 shows packaging bases supplied on a conveyor belt for a closing process using labels;

FIG. 3 shows packaging bases supported on lateral conveyor belts for a closing process using labels; and

FIG. 4 is a fragmentary top view of the lateral conveyor belts of FIG. 3 and showing a packaging base received between the conveyor belts.

Same components are provided with the same reference characters throughout the figures.

### DETAILED DESCRIPTION

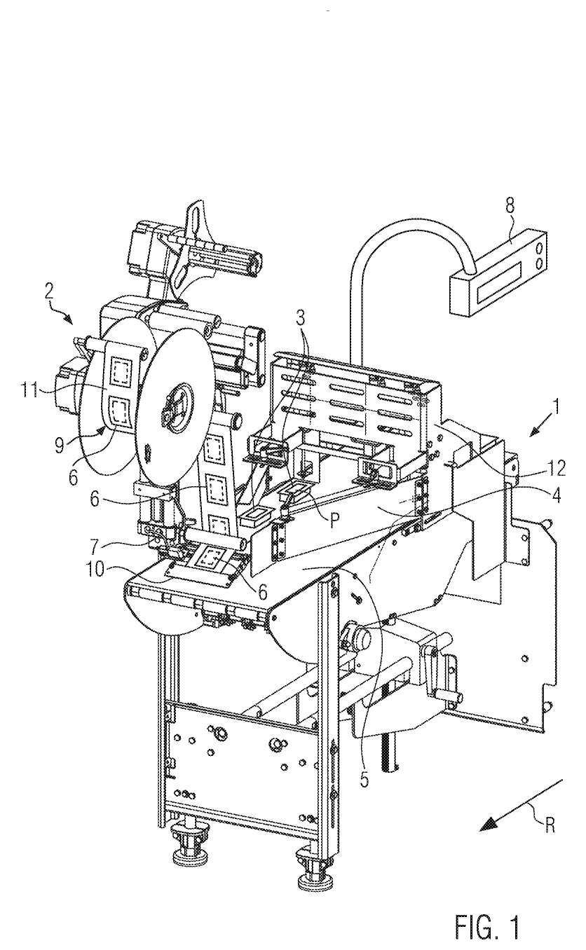

FIG. 1 shows a packaging machine 1. Packaging machine 1 comprises a label dispenser 2. Packaging bases 3, which are not yet provided with a lid, are supplied by way of packaging machine 1 in direction of production R to label dispenser 2.

Two guide rails 4 are positioned converging toward each other such that a gap or opening for packaging bases 3 is created at the downstream end of guide rails 4 and is only slightly wider than the width of packaging bases 3 themselves.

This allows packaging bases 3, which are transported on packaging machine 1 by way of a conveyor belt 5 running therealong, to be accurately supplied to label dispenser 2. This in turn enables a label 6 to be accurately glued to a supplied packaging base 3 in order to close packaging base 3.

A sensor 7 provided on label dispenser 2 can detect a leading edge of a packaging base 3 to be labeled and closed while packaging base 3 is being transported along guide rails 4. Sensor 7 can be configured as a light barrier or proximity sensor and is connected to a controller 8 and transmits the signal to the latter, namely the detection of the leading edge of packaging base 3. Controller 8 controls the motion of label 6 to be dispensed by way of the speed and path of a label roll 9 attached to label dispenser 2 toward and along a dispensing edge 10 in order to detach label 6 from a carrier belt or carrier layer 11 and apply it to packaging base 3.

The speed of the label roll 9 during the dispensing process onto packaging base 3 is synchronized with the speed of conveyor belt 5.

Arranged upstream of label dispenser 2 is a stopper device 12 forward of guide rails 4 on packaging machine 1 to stop packaging bases 3 while conveyor belt 5 is running. Stopped packaging bases 3 can then be released one by one for the labeling process at label dispenser 2.

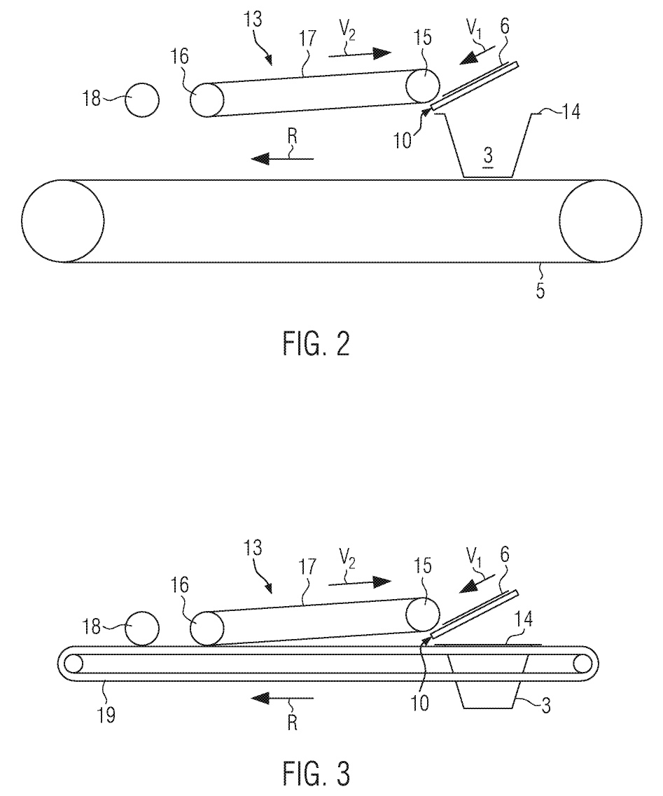

According to FIG. 2, a belt device 13 is associated with dispensing edge 10 of label dispenser 2. In particular, FIG. 2 shows that dispensing edge 10 protrudes into the region of the inlet of belt device 13. Belt device 13 is thus able to receive labels 6 directly at dispensing edge 10, to merge them with packaging bases 3 supplied in direction of production R, and to press them onto tray edges 14 of packaging bases 3.

This means that, in FIG. 2, the lid members formed from labels 6 are already taken over at dispensing edge 10 by belt device 13 associated with dispensing edge 10, i.e., before they are completely detached from carrier layer 11. This allows labels 6 to be smoothly transferred from carrier layer 11 to belt device 13.

FIG. 2 further shows that the lid members formed from labels 6 are merged with respective tray edges 14 of the supplied packaging bases 3 for the closing process and, due to the inclined orientation of belt device 13, are pressed on along tray edges 14 at least in sections. An advancement speed v1 of labels 6 is synchronized with a belt speed v2 of belt device 13. This allows labels 6 to be transferred from carrier layer 11 to belt device 13 in a controlled manner.

Belt device 13 comprises a deflection or drive roller 15 mounted above dispensing edge 10 and a deflection or drive roller 16 mounted downstream in direction of production R. Belt device 13 also comprises a press-on belt 17. Press-on belt 17 can be configured in the form of a damper belt with cavities for generating an increasing press-on force for closing packaging base members 3 with the lid members formed from labels 6.

According to FIG. 2, belt device 13 is mounted at an incline because the deflection or drive roller 15 positioned at the inlet of belt device 13 is mounted higher than the deflection or drive roller 16 positioned at the outlet of belt device 13.

Due to the inclined position of belt device 13 shown in FIG. 2, it is possible to receive labels 6 at dispensing edge 10 by way of belt device 13 at a time when labels 6 are not yet completely detached from carrier layer 11. Consequently, a smooth transfer of labels 6 to belt device 13 at the dispensing edge 10 takes place because labels 6 are already in engagement at the front by way of belt device 13 while they are still stuck to carrier layer 11 further back. By synchronizing feed speed v1 with belt speed v2 of belt device 13, smooth detachment of label 6 from carrier layer 11 and smooth transfer of label 6 to belt device 13 takes place.

According to FIG. 2, a driven roller 18 is positioned downstream of belt device 13. Roller 18 serves to additionally press labels 6 on along tray edges 14 of packaging bases 3. In FIG. 2, in direction of production R, labels 6 are consequently initially pressed onto tray edges 14 of packaging bases 3 at the outlet of belt device 13, and then pressed on again downstream by driven roller 18.

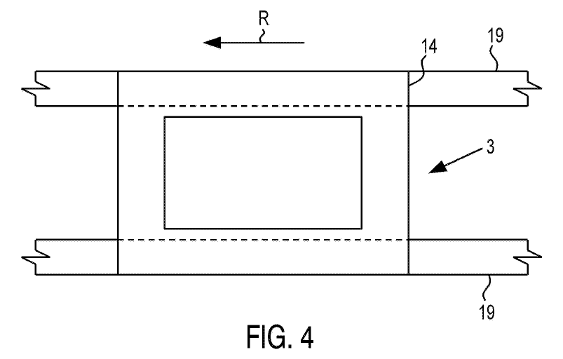

FIGS. 3 and 4 show the device shown in FIG. 2, where instead of conveyor belt 5 shown in FIG. 2, lateral conveyor belts 19 are employed in FIGS. 3 and 4 for feeding packaging bases 3 received therebetween.

Using lateral conveyor belts 19, which form vertical side belts in particular, it is possible for oppositely disposed sections of tray edges 14 of packaging bases 3 transverse to direction of production R to be supported from below when belt device 13 presses labels 6 onto tray edges 14 from above.

What is claimed is:

1. A method for producing a package in a direction of production, comprising:
providing a label roll comprising prefabricated labels and a carrier layer onto which the labels are adhesively attached;
providing packaging bases loaded with a product;
separating the labels from the carrier layer at a dispensing edge, wherein the labels form lid members for the packaging bases; and
closing the packaging bases in a closing process to form closed packages in which the lid members formed from the labels are each adhesively attached along a respective tray edge formed on a respective packing base of the packaging bases;
wherein the lid members are received at the dispensing edge by a belt device that is associated with the dispensing edge and that merges the lid members with the respective tray edges of the packaging bases for the closing process and that presses the labels forming the lid members on along the tray edges at least in sections.

2. The method according to claim 1, wherein an advance speed of the lid members over the dispensing edge and a belt speed of the belt device are synchronized.

3. The method according to claim 1, wherein tray edges of the packaging bases are supported from below at least in sections during the closing process.

4. The method according to claim 3, wherein the tray edges of the packaging bases rest on conveyor belts.

5. The method according to claim 4, wherein the packaging bases are transported affixed between the conveyor belts in a predetermined orientation for the closing process.

6. The method according to claim 1, wherein the belt device is operated at an incline so that it guides the lid members in the direction of production while the lid members increasingly approach the packaging bases.

7. The method according to claim 1, wherein the lid members adhesively attached to the tray edges are pressed on again along the respective tray edges by a driven roller mounted in the direction of production downstream of the belt device.

8. The method according to claim 1, wherein the belt device is heated.

9. The method according to claim 1, wherein a press-on force that can be generated upon the lid members by way of the belt device is dynamically controlled.

10. A packaging machine comprising a label dispenser with a dispensing edge for separating labels from a carrier layer, and a belt device associated with the dispensing edge such that the labels can be received thereby at the dispensing edge, can be merged with respective packaging bases supplied in a direction of production, and can be pressed onto tray edges of the respective packaging bases.

11. The packaging machine according to claim 10, wherein the belt device comprises a deflection or drive roller mounted above the dispensing edge.

12. The packaging machine according to claim 10, wherein the belt device is mounted at an incline.

13. The packaging machine according to claim 10, further comprising synchronously drivable conveyor belts that are disposed opposite each other transverse to the direction of production for supporting sections of the tray edges of the packaging bases.

14. The packaging machine according to claim 13, wherein the packaging bases can be transported affixed between the conveyor belts in a predetermined orientation at least transverse to the direction of production.

15. The packaging machine according to claim 10, further comprising at least one drivable roller for pressing the labels on along the tray edges in the direction of production downstream of the belt device.

16. The packaging machine according to claim 10, wherein a press-on force exerted upon the labels by the belt device is dynamically controllable and/or the belt device is formed to be heatable.
